(19) United States
(12) Patent Application Publication
(10) Pub. No.: US 2017/0247179 A1
(43) Pub. Date: Aug. 31, 2017

(54) CAPSULE FOR A BEVERAGE PREPARATION

(71) Applicant: David RUBINSTEIN, Aartselaar (BE)

(72) Inventor: David RUBINSTEIN, Aartselaar (BE)

(21) Appl. No.: 15/512,120

(22) PCT Filed: Sep. 17, 2014
(86) PCT No.: PCT/EP2014/069845

§ 371 Date: Mar. 17, 2017

(51) Int. Cl. B65D 85/804; A47J 31/40

(52) U.S. Cl. CPC B65D 85/8043; A47J 31/407

(57) ABSTRACT

A capsule 10 for the preparation of a beverage, comprising a body 11, and a rim structure 12 having an edge 14 extending outwardly with respect to an outer surface of the body 11; and a contact element 13 which protrudes from a remaining portion of an upper surface 19 of the rim structure 12 thereby forming an annular channel 18 between the outer surface of the capsule body 11 and an inner side wall 17 of the contact element 13; the capsule being configured to cooperate with a beverage preparation apparatus and characterised in that the contact element 13 is located at a predetermined distance away from the edge 4 of the rim structure 12.

### TECHNICAL FIELD

The present invention relates to a capsule for the preparation of a beverage, such as coffee, milk, tea, etc., to a beverage preparation apparatus for use in connection with such capsule, and to a method for producing such capsule.

### BACKGROUND ART

Capsules used in combination with an apparatus for the preparation of a beverage, such as coffee or tea, are well known in the art. These capsules offer a convenient way of making a beverage having a predetermined quality in an easy and quick manner.

An exemplified way of preparing a beverage using a capsule in combination with an apparatus is described below. The beverage preparation may start by inserting the capsule in an internal chamber of the apparatus, and further securing the capsule into the desired position by a closing mechanism of the apparatus. The beverage can be prepared inside the capsule by using a mechanism to inject a fluid, such as water, under pressure. The fluid injecting mechanism can be part of the closing mechanism and may be arranged to penetrate the capsule body at a predetermine location. The capsule may further comprise an opening, which may be closable by a thin film, e.g. aluminium foil, or a membrane. During the preparation of the beverage, the fluid injecting mechanism injects fluid into the capsule, thereby causing a pressure build up inside the capsule, which in turn may cause the thin film closing the capsule opening to expand outwardly. The thin film is arranged to erupt at a predetermine pressure either automatically or by coming in contact with another surface of the apparatus that can be arranged to penetrate the thin film in a predetermined way, thereby enabling the extraction of the beverage.

EP2029457 relates to a coffee capsule with a deformable sealing element. The deformable sealing element is in the form of a rollover edge, and is arranged to deform under a predetermined amount of pressure exerted by a holding-down device and/or counterpart of an extraction device, i.e. closing mechanism. In order to achieve appropriate sealing action, the holding-down device and/or counterpart needs to have a certain shape to deform the rollover edge at a predetermine direction, as disclosed therein.

EP2489609 relates to a capsule for containing a preparation for a hot drink and comprises an annular groove, which forms the sealing element, destined to sealingly receive the upper peripheral edge of the containing wall of the internal chamber of an apparatus, i.e. the closing mechanism. The groove in this case is sized according to the peripheral edge of the containing wall of the internal chamber of the apparatus, so as to form a fluid-tight barrier. Therefore, the capsule disclosed in EP2489609 can be considered as being compatible only with an apparatus having a peripheral edge that is sized and positioned according to the opening of the groove.

Both prior art solutions presented above concentrate on providing a fluid-tight barrier arrangement around the capsule using a contact member that is arranged to deform or compress under the pressure of the closing member of the beverage apparatus. However, the provision of a fluid tight barrier arrangement according to the prior art solutions may substantially increase the manufacturing cost of the individual capsule, which is then transferred to the consumer. Moreover, the fluid-tight barrier arrangement of the prior art solutions can only be guaranteed for capsules that have been especially designed to cooperate with the closing member of a specific beverage apparatus. As a result, the available options to the consumer for choosing a beverage apparatus and/or capsules from a different manufacturer are limited.

### DISCLOSURE OF THE INVENTION

It is an aim of the present invention to provide a capsule for preparing a beverage that is compatible with different types of beverage apparatuses without compromising the quality of the extracted beverage.

According to a first aspect of the present invention, this aim is achieved with the capsule for preparing a beverage showing the technical characteristics of the characterising part of the first claim.

More in particular according to the present invention a capsule for the preparation of a beverage is provided. The capsule comprises a body that has a suitable shape, e.g. beaker-shaped, cup-shaped, etc, for holding a dose of a beverage ingredient, such as coffee, tea, milk, and the like. A rim structure may be provided on the outer surface of the capsule body, an edge of which may be arranged to extend outwardly from the outer surface of the capsule body, thereby forming an intermediate region between the rim structure edge and the capsule body. A contact element may further be provided on the rim structure, which protrudes from a remaining portion of an upper surface of the rim structure, i.e. the intermediate region previously described, thereby forming an annular channel between the outer surface of the capsule body and an inner side wall of the contact element facing the outer surface of the capsule body. For the preparation and extraction of the beverage, the capsule may be arranged to cooperate with a beverage preparation apparatus. The apparatus may at least comprise an inner chamber arranged for receiving the capsule body and a closing mechanism arranged for securing the capsule in the inner chamber. The contact element can be provided on the rim structure at a predetermined distance away from the edge of the rim structure.

It has been found that by positioning the contact element away from the edge of the rim structure, i.e. in the intermediate region previously discussed, the capsule according to the embodiments of the present invention may be used in combination with a variety of beverage preparation apparatuses currently on the market without substantially compromising the quality of the extracted beverage.

According to embodiments of the present invention, the closing mechanism may be arranged to be movable between a closed and an open position. According to embodiments of the present invention, the closing mechanism may be arranged to apply a predetermined force on the contact element when in the closed position.

According to embodiments of the present invention, the beverage preparation apparatus may be further provided with a mechanism for injecting in the inner chamber of the beverage apparatus a liquid under a predetermined pressure.

According to embodiments of the present invention, at least part of the contact element may be arranged to cooperate with the closing mechanism of the beverage apparatus, when said closing mechanism is in the closed position, such that when the liquid is injected under pressure by the injecting mechanism the liquid at least partially flows through the capsule. According to embodiments of the present invention, the contact element of the capsule may be arranged to engage a corresponding surface of the closing mechanism, so as to ensure that a substantial amount of the pressurised liquid injected in the inner chamber flows through the capsule, and therefore may flow along a dose of a beverage ingredient contained in the body of the capsule, which may cause a pressure built-up inside the capsule leading to the eruption of a thin film closing the opening of the capsule body.

According to embodiments of the present invention the contact element is arranged to maintain a barrier in cooperation with the closing mechanism at fluid pressures ranging between 1.0 and 40.0 bars. According to embodiments of the present invention, the barrier may be arranged to be a fluid tight barrier, while the contact element may be arranged as a sealing element. According to embodiments of the present invention, at least part of the contact element may be arranged such that, when the closing mechanism is in the closed position, it is plastically deformed by a corresponding surface of the closing mechanism, for example under the influence of the predetermined force.

The deformation of the contact element may result in the formation of a fluid-tight barrier between the contact element and the closing mechanism, which may be able to withstand higher fluid pressures. The provision of a fluid-tight barrier may ensure that a higher amount of liquid is directed through the capsule, thereby leading to a higher pressure built-up inside the capsule, which may further lead to a beverage having an enhanced flavour and aroma. Furthermore, the plastic deformation of the contact element may result in compensating height differences between the contact element and the closing mechanism resulting from the use of the capsule in a beverage apparatus having a different closing mechanism arrangement, so as to ensure that the capsule according to embodiments of the present invention remains compatible with a variety of beverage preparation apparatuses.

According to embodiments of the present invention the inner sidewall of the contact element may be inclined with respect to a corresponding plane of the capsule. According to one embodiment, at least the inner side wall of the contact element can be arranged at an angle with respect to an imaginary plane, which can be positioned in contact with a proximal end of the inner side wall that meets the upper surface of the rim structure and perpendicular to the remaining portion of the upper surface of the rim structure.

This orientation of the inner sidewall may enable the closing mechanism to plastically deform the contact element more effectively, which may result in a higher amount of the pressurised liquid injected in the inner chamber being directed through the capsule. Moreover, in the case where the contact element is deformed by the closing mechanism, the angle of the inner sidewall may enhance this deformation so that a higher resistance fluid-tight barrier is formed between the contact element and the closing mechanism of the apparatus that may withstand higher pressures. compared with known solutions. Moreover, the angle of the inner sidewall in combination with the provision of the annular channel between the outer surface of the capsule body and contact element may further ensure that the contact element is equally deformed around the capsule, thereby enhancing the pressure resistance of the fluid tight barrier formed between the contact element and the closing mechanism.

According to embodiments of the present invention, the contact element may be arranged not to be deformed by the closing mechanism, for example by correspondingly dimensioning the contact element with respect to the closing mechanism. According to further embodiments, the contact element may be configured such that after positioning the closing mechanism in the closed position a small gap remains between contact element and the corresponding surface of the closing mechanism. It has been found that the provision of a gap does not substantially affect the built-up of pressure inside the capsule.

According to embodiments of the present invention, the angle of the inner side wall of the contact element may be preferably less than 90.0 degrees. More in particular the angle of the inner side wall of the contact element may be at least 1.0 degrees, at most 90.0 degrees, preferably at most 70.0 degrees, more preferably at most 60.0 degrees, even more preferably at most 50.0 degrees.

Although other angles may be considered, it has been found that by arranging the inner sidewall at the above-mentioned angles a more effective cooperation between the contact element and the closing mechanism may be achieved. Moreover, in the case where the contact element is deformed by the closing mechanism a higher deformation may be achieved, leading to the formation of a higher quality fluid-tight barrier that can withstand higher pressure amounts.

According to certain embodiments of the present invention, the contact element may be arranged to plastically deform in the direction of inclination of at least the inner sidewall, which may be preferably away from the outer surface of the capsule body. Preferably, the direction of inclination may be towards the edge of the rim structure. However, the present invention is not limited by any means to this direction and that other directions of inclination may be considered.

By orienting the direction of inclination towards the rim edge, it may have the effect that when the closing mechanism is in the closed position the annular channel remains unobstructed, which may enhance the cooperation between the contact element and the closing mechanism, leading to higher amount of the pressurised liquid being directed through the capsule. Moreover, in the case where the contact element is deformed by the closing mechanism, the fact that the annular channel remains unobstructed may enable a uniform deformation of the contact element, resulting in an improved fluid-tight barrier.

According to embodiments of the present invention, the contact element may be integrally formed with the rim structure, so that the contact element in combination with the rim structure may be formed as a single piece made from the same material. Furthermore, the rim structure may be integrally formed with the capsule body, which means that the rim structure and the capsule body and by extension the contact element may be formed as a single piece made from the same material.

It has been found that by using the material of the rim structure to form the contact element has the advantage that it may eliminate the need for using secondary-based materials on the ring structure, such as rubber-based rings or membranes, which may reduce the manufacturing cost of the capsule. Furthermore, by forming the contact element as part of the rim structure may result in enhancing the pressure resistance of the fluid-tight barrier formed when the contact element is deformed, leading to a higher pressure built up inside the capsule, which may thereby enhance the quality of the beverage. In particular, it has been found that the formation of the contact element using this arrangement, results in a pressure built up inside the capsule in the range of 1.0 bar up to and including 40.0 bars. A further advantage of using this approach for forming the contact element may be the simplification of the manufacturing process due to the elimination or at least further decrease of the use of different material having different manufacturing tolerances.

According to embodiments of the present invention, the contact element protruding from the rim structure may be hollow. By making the contact element hollow, a more effective deformation of the contact element may be achieved, thereby leading to a higher quality fluid-tight barrier. However, the contact element may be also filled with another material, for example a composite material, for example for controlling the deformation of the contact element, if deformation is present.

According to embodiments of the present invention, the capsule, for example the body, rim structure and the contact element, can be made at least in part from a metal-based alloy, such as aluminium-based alloy. However, the capsule, for example body, rim structure and the contact element, may be further made at least in part from plastic, such as a thermoplastic material. Furthermore, the capsule, for example the body, rim structure and the contact element, can be further made from a combination of materials, e.g. a plastic material coated with an aluminium-based alloy.

The use of metal-based or plastic materials for the production of the capsule may considerable enhance the recyclability, food safety and traceability of the capsule in comparison to the capsules known in the art.

According to embodiments of the present invention, the height of the contact element as measured from the remaining portion of the upper surface of the rim structure to the highest point of the contact element, can be at least 0.2 mm, at most 3.5 mm, preferably at most 3.0 mm, more preferably at most 2.0 mm, even more preferably at most 1.5 mm.

According to embodiments of the present invention, the distance of the contact element from the outer surface of the capsule body, measured from the highest point of the contact element along a horizontal imaginary plane which is substantially parallel to the remaining portion of the upper surface of the rim structure, can be at least 0.1 mm, at most 2.0 mm, preferably at most 1.5 mm, and even more preferably at most 1.0 mm.

It has been found that the height of the contact element and distance of the contact element from the outer surface may enable the capsule to be used with a wider variety of beverage apparatus, each having a closing mechanism that may be different. By providing a contact element that can be plastically deformed by the closing mechanism, it can also be further ensured that a capsule having a contact element of a predetermined height remains compatible with a variety of beverage apparatuses

According to embodiments of the present invention, the capsule body may be provided with a plurality of geometrical facets, which may cover at least part of the capsule body.

The facets may be provided for enhancing the grip of the capsule body, when the capsule is manipulated or held by a user or a machine for positioning the capsule in a beverage preparation device. Furthermore, the facets may facilitate a better fit of the capsule in the inner chamber of the beverage preparation apparatus. Moreover, the provision of facets may enhance the appearance of the capsule to a potential buyer, by reflecting the light in multiple directions thereby enhancing viewing of the capsule's colour, which may indicate a particular aspect of the beverage ingredient, such as the strength or aroma of the beverage.

According to embodiments of the present invention, the capsule may be compatible with a known beverage preparation apparatus comprising at least an inner chamber for receiving the capsule according to embodiments of the present invention. A closing mechanism may further be provided to the apparatus for securing the capsule in the inner chamber, which may be movable between a closed and an open position. The beverage preparation apparatus may further comprise a mechanism for injecting a fluid, such as water, under predetermined pressure inside the capsule for preparing the beverage, and a mechanism for extracting the beverage from the capsule. According to embodiments of the present invention, the capsule as previously described may be arranged to cooperate with the closing mechanism such that when the closing mechanism is moved to the closed position a substantial amount of the pressurised liquid injected during the beverage preparation process may be directed through the capsule.

According to a second aspect of the invention, a method is provided for operating a beverage preparation apparatus together with the capsule according to embodiments of the present invention for preparing a beverage. The method comprises the steps of ensuring that the closing mechanism is ready for receiving a capsule and that the inner chamber is empty, i.e. if it has been used before, the previous used capsule has been removed. The next step is to position the capsule in the inner chamber of the beverage preparation device and, preferably, secure the capsule by positioning the mechanism in the relevant position. Once the capsule is for example secured in the inner chamber, the mechanism for injecting fluid under pressure, such as water, is activated for a predetermined amount of time. Once the pressure in the capsule reaches a predetermined value the thin film covering the opening may be erupted automatically or by coming in contact with another surface of the apparatus and the beverage extracted from the capsule is collected.

According to a third aspect of the invention, a method for producing the capsule body according to the present invention is provided. The method includes the steps of pre-forming the capsule body and at least a portion of the rim structure from a single piece of material using a suitable forming device. The contact element can be provided at predetermined distance from the edge of the rim structure

According to embodiments of the present invention, the contact element may be provided on the rim structure in the form of an annular channel by applying pressure on the rim structure using an imprinter device having a predetermined shape. Furthermore, the contact element may be formed by a separate step of the process or together with the formation of the capsule body and the rim structure.

### BRIEF DESCRIPTION OF THE DRAWINGS

The invention will be further elucidated by means of the following description and the appended figures.

FIG. 1 shows a top view of a capsule according to embodiments of the present invention.

FIG. 2 shows a side view cross-section of the capsule of FIG. 1.

FIGS. 3 to 6 show different close-up views of the capsule's rim structure area according to the present invention.

FIG. 7 shows an exemplified series of steps for producing a capsule according to the present invention.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

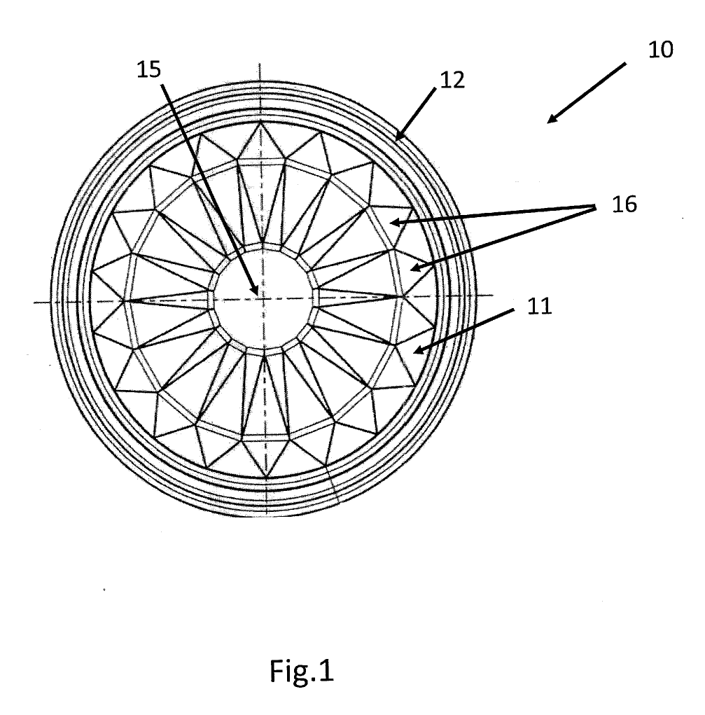

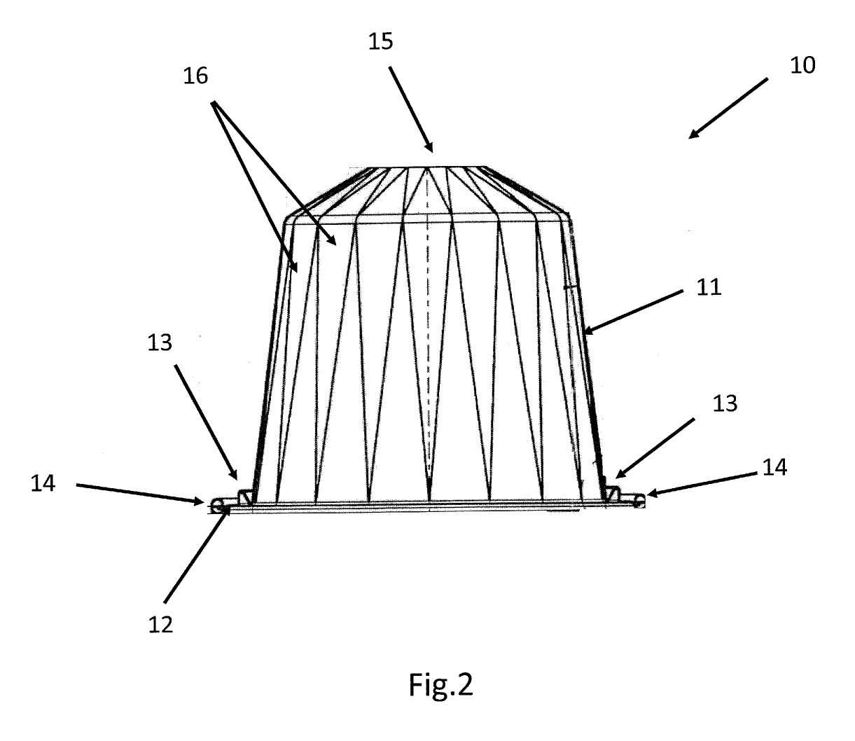

FIGS. 1 and 2 show different views of the capsule 10 according to embodiments of the present invention. The capsule 10 may be provided with a body 11, which has a suitable shape for holding a dose of a beverage ingredient(s). For example, the body 11 may be beaker-shaped or cup-shaped provided with a cavity (not shown) for holding the dose of the beverage ingredient(s). The outer surface of the capsule body 11 when viewed from the top may be substantially circular. However, other shapes known in the art, which are compatible with beverage preparation apparatus, may also be considered, such as elliptical, conical, square, etc. Furthermore, the outer surface of the body may be provided with a plurality of geometrical facets covering at least part of the capsule body 11. The geometrical facets 16 may radiate from a top portion 15 of the capsule body 11 towards the base of the capsule body 11. At the base of the capsule body, which may be located at the opposite end with respect to the top portion 15 of the capsule body 11, an opening (not shown) may be provided for supplying the beverage ingredient(s) to the cavity of the capsule body 11. The opening may be closable by a thin film or a membrane, which during the beverage preparation may be arranged to erupt due to the pressure built up inside the capsule, thereby enabling for the extraction of the beverage from the capsule. The outer surface of the capsule body 11 may be further provided with a rim structure 12 having an edge 14 extending outwardly in substantially perpendicular direction with respect to the capsule body 11. As shown in FIG. 1, the rim structure 12 may be provided continuously around the capsule body 11, thereby forming an intermediate region between the rim structure edge 14 and the capsule body 11, which may act as a support surface for the capsule 10 when placed in a beverage preparation apparatus.

FIG. 2 presents a cross-sectional side view of the capsule 10, which may help in further describing certain features of the capsule 10. As shown in FIG. 2, the rim structure 12 may further be provided with a contact element 13 on the intermediate region formed between the rim structure edge 14 and the capsule body 11. The contact element 13 may be arranged to protrude from the intermediate region.

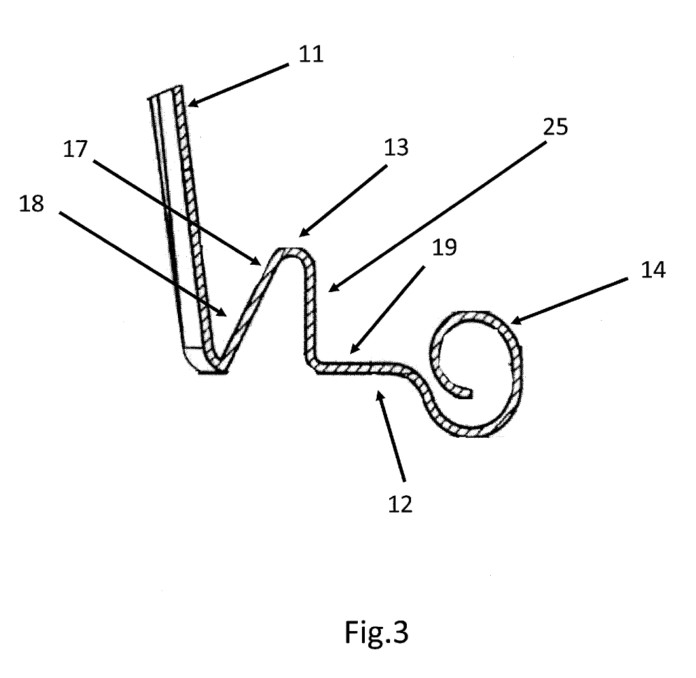

The contact element 13 and further features of the rim structure 12 may be further described with references to FIGS. 3 to 6, which show a close-up cross-sectional view of the region around the rim structure 12. According to some embodiments, the rim structure edge 14 may be arranged in the form of a rollover edge, which may be formed by rolling part of the rim structure 12 thereby leaving a remaining portion of the intermediate region for providing the contact element 13. The contact element 13 may be arranged to protrude from an upper surface 19 of the remaining portion of the intermediate region of the rim structure. In this orientation, an annular channel 18 may be formed around the capsule body 11 between the outer surface of the capsule body 11 and an inner side wall 17 of the contact element. Therefore, it can be said that the contact element 13 may be arranged such that a gap is formed between the outer surface of the capsule body 11 and the inner side wall 17 of the contact element 13. Furthermore, the contact element 13 may be located at a predetermined distance from the rim structure edge 14. As previously discussed, the location of the contact element 13 with respect to the rim structure edge 14 may be influential in enhancing the cooperation between the contact element and the closing mechanism of a beverage preparation machine such that when pressurised liquid is injected in the inner chamber a substantial amount of the liquid is directed through the capsule.

According to embodiments of the present invention, the contact element 13 may be arranged to function as a sealing element thereby forming a barrier in cooperation with the closing mechanism 20 at fluid pressures ranging between 1.0 and 40.0 bars. According to embodiments of the present invention, the barrier formed may be a fluid-tight barrier, which may be achieved by configuring the contact element to be plastically deformed by a predetermine pressure force applied by the closing mechanism 20, when moved from an open position to a closed position.

According to further embodiments, the contact element 13 may be arranged not to be deformed by the closing mechanism 20. For example, the closing mechanism 20 may engage at least part of the contact element 13 without any deformation. In other examples, a small gap may be formed between the closing mechanism 20 and the contact element 13, which may allow some of the liquid injected under pressure by the injection mechanism to flow on the outer surface of the capsule 10.

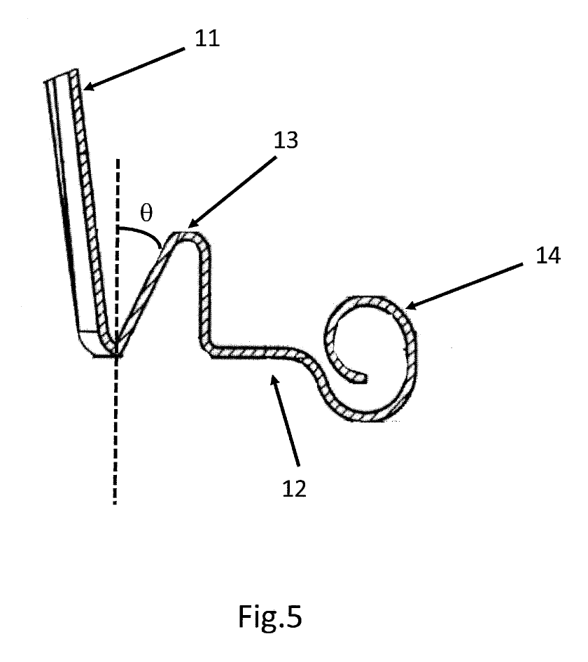

The contact element 13 may be further arranged to protrude from the remaining portion of the intermediate region of the rim structure at a predetermine angle. As shown in FIG. 5, the inner sidewall 17 of the contact element 13 can be arranged at an angle (θ) with respect to an imaginary plane (shown with a dotted line), which is positioned in contact with a proximal end of the inner sidewall 17 that meets the upper surface 19 of the remaining portion of the rim structure 12 and perpendicular to the upper surface 19 of the rim structure 12. According to preferred embodiments, the angle (θ) formed between the imaginary plane and the inner sidewall 17 of the contact element 13 may be preferably equal to or less than 90.0 degrees. More in particular, the angle (θ) of the inner sidewall may preferably be at least 1.0 degrees, at most 90.0 degrees, preferably at most 70.0 degrees, more preferably at most 60.0 degrees, even more preferably at most 50.0 degrees. By positioning the contact element 13 at an angle (θ) may lead to a more effective cooperation between the contact element 13 and the closing mechanism 20. Furthermore, by positioning the contact element 13 at an angle (θ) may lead to a higher deformation of the contact element 13, when it is configured as a sealing element, by the force applied by the closing mechanism 20, which in turn may lead to a higher quality fluid-tight barrier between the closing mechanism 20 and the contact element 13. It should be understood, although not shown, that also the outer sidewall 25 of the contact element may also be arranged at an angle (θ) with respect to an imaginary plane, which can be positioned in contact with a proximal end of the outer sidewall 25 that meets the upper surface 19 of the remaining portion of the rim structure 12 and perpendicular to the upper surface 19 of the rim structure 12. Furthermore, both the outer sidewall 25 and the inner sidewall 17 may be arranged at an angle (θ).

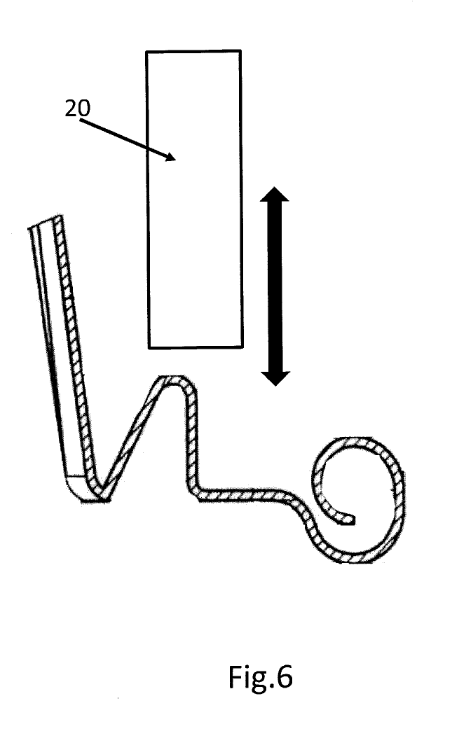

FIG. 6 shows an example of a closing mechanism 20 of a beverage apparatus (not shown) in cooperation with a contact element 13. According to embodiments of the present invention, the closing mechanism 20 may be arranged to secure the capsule 10 in the inner chamber of a beverage preparation apparatus (not shown). The closing mechanism 20 may be arranged to cooperate with the contact element 13 to form a barrier such that when the pressurised liquid is injected in the inner chamber of the beverage apparatus a substantial amount of said liquid is directed through the capsule 10. For example, the barrier may be formed configuring the closing mechanism 20 for engaging a contact surface of the contact element without any deformation. In another example, a sufficient barrier may be formed even in the presence of a gap having substantially small dimensions formed between the closing mechanism 20 and the contact element 13.

According to further embodiments of the present invention, the closing mechanism 20 may be further arranged to seal the capsule in the inner chamber. The sealing of the capsule can be achieved by applying a predetermined sealing force to the contact element 13 being configured as a sealing element, thereby causing at least part of the contact element 13 to deform such that a fluid-tight barrier is formed between the closing mechanism 20 and the contact element 13, which may enhance the quality of the quality of the beverage extracted, as previously discussed.

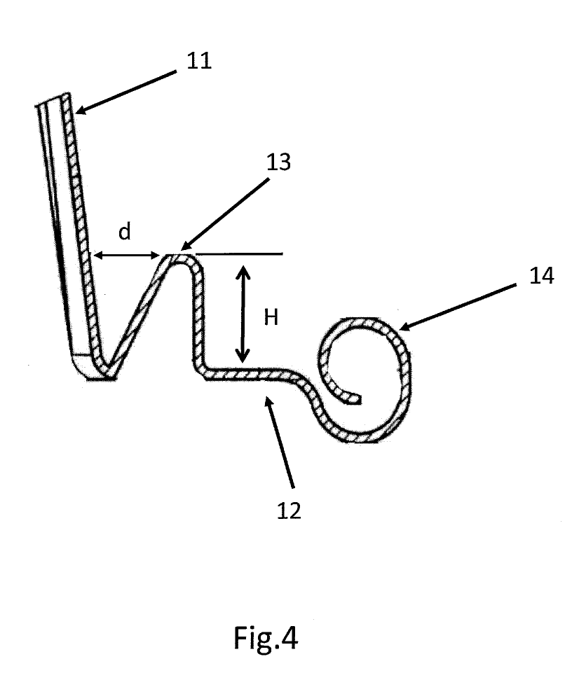

According to embodiments of the present invention, in order to make the capsule 10 compatible with a wide range of beverage preparation apparatuses having different closing mechanisms 20, the height and distance of the contact element may be adapted. As shown in FIG. 4, the distance of the contact element 13, measured from the outer surface of the capsule body 11 to the highest point of the contact element 13, may be preferably at least 0.1 mm, at most 2.0 mm, preferably at most 1.5 mm, and even more preferably at most 1.0 mm.

Furthermore, the contact element 13 may be provided to have a predetermine height, which may be measured from the upper surface 19 of the rim structure 12 to the highest point of the contact element 13, as shown in FIG. 4. The height of the contact element 13 may be preferably at least 0.2 mm, at most 3.5 mm, preferably at most 3.0 mm, more preferably at most 2.0 mm, even more preferably at most 1.5 mm.

The capsule 10 according to embodiments of the present invention has the advantage that it may be used with a variety of beverage apparatuses known in the prior art. With the capsule of the present invention, a high pressure barrier may be formed, which can withstand pressure amounts in the range of 1.0 to 40.0 bars irrespective of the shape and dimensions of the closing mechanism 20 of the beverage apparatus.

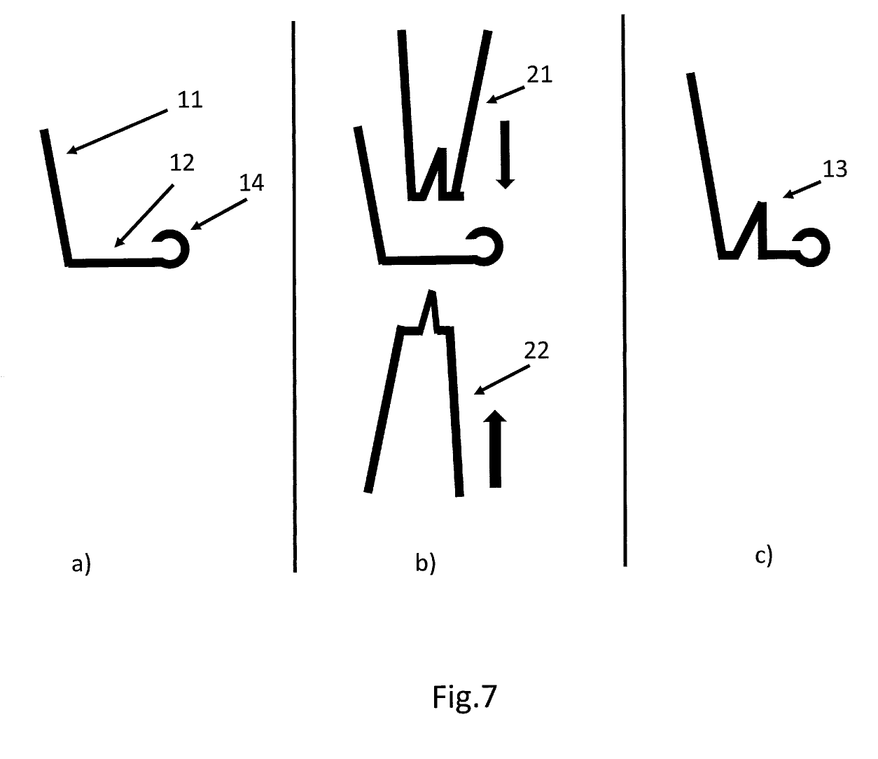

FIG. 7 shows the steps of an exemplified method for producing a capsule body 11 according to the present invention for use in beverage apparatus known in the art. The exemplified method may start by providing a preformed capsule body 11, as shown in step a). As shown therein, the rim structure 12 can be integrally formed with the capsule body 11. For example, the capsule body 11 and the rim structure 12 can be made as a single piece from the same material. In general, a wide variety of materials may be used for making the capsule body, and by extension the rim, which may include but not limited to metal based materials, such as Aluminium-based alloy or plastic-based, such as thermoplastic and the like. Also, the capsule body 11, and by extension the rim structure 12, may be made by a plastic-based material coated with a metal-based alloy, such as aluminium. The second step (step b) of the exemplified method may be to provide the contact element 13 on the rim structure 12 at a predetermined location away from the rim structure edge 14. According to one embodiment of the present invention, the contact element 13 can be provided by applying a predetermine pressure on the rim structure 12 using an imprinter device having a first counterpart 21 and a second counterpart 22. The two counterparts 21 and 22 may be arranged to move towards one another thereby producing by means of pressure on the rim structure 12 the contact element 13 as shown in step c) of the exemplified method. As may be seen, using this exemplified method, the contact element 13 may be provided as a hollow structure integrally formed with the rim structure 12, i.e. as a single piece made from the same material. Therefore, according to embodiments of the present invention the capsule body, rim structure and contact element may be made from the same material as a single piece. However, it should be noted that the contact element 13 may be filled with a composite material, for example for controlling the deformation of the contact element 13 by the closing mechanism. Furthermore, it should be noted that other manufacturing methods known in the art can be employed for producing the capsule body.

1. A capsule (10) for the preparation of a beverage, the capsule (10) comprising:
a body (11) having a shape suitable for holding a dose of a beverage ingredient, and a rim structure (12) having an edge (14) extending outwardly with respect to an outer surface of the body (11); and
a contact element (13) which protrudes from a remaining portion of an upper surface (19) of the rim structure (12) thereby forming an annular channel (18) between the outer surface of the capsule body (11) and an inner side wall (17) of the contact element (13) facing the outer surface of the capsule body (11);
the capsule (10) being configured to cooperate with a beverage preparation apparatus comprising at least an inner chamber arranged for receiving the capsule body, a closing mechanism (20) for securing the capsule (10) in the inner chamber
characterised in that the contact element (13) is located at a predetermined distance away from the edge (14) of the rim structure (12).

2. The capsule according to claim 1, wherein the closing mechanism is movable between an open and a closed position, in which closed position the closing mechanism (20) is arranged for securing the capsule (10).

3. The capsule according to claim 1 or 2, wherein the beverage preparation apparatus comprises a mechanism for injecting in the inner chamber of the beverage apparatus a liquid under a predetermined pressure.

4. The capsule according to claim 3, wherein the contact element (13) of the capsule is arranged to cooperate with the closing mechanism (20) of the beverage preparation apparatus such that when the pressurised liquid is injected by the injecting mechanism in the inner chamber the liquid at least partially flows through the capsule.

5. The capsule according to any one of claims 1-4, wherein the contact element (13) is arranged to maintain a barrier in cooperation with the closing mechanism (20) at fluid pressures ranging between 1.0 and 40.0 bars.

6. The capsule according to claim 5, wherein the barrier between the contact element (13) and the closing mechanism (20) is a fluid-tight barrier, the contact element (13) being a sealing element (13).

7. The capsule according to any one of claims 1-6, wherein the closing mechanism (20) secures the capsule (10) in the inner chamber by applying a predetermined force on the contact element (13).

8. The capsule according to claim 7, wherein the contact element (13) is a sealing element (13), wherein the closing mechanism (20) seals the capsule (10), wherein the predetermined force on the sealing element (13) is a sealing force on the sealing element (13) and wherein at least part of the sealing element (13) is arranged such that the sealing element (13) under the sealing force applied by the closing mechanism (20) is plastically deformed.

9. The capsule according to claim 8, wherein the sealing element (13) plastically deformed in such a manner that a fluid-tight barrier is formed between the sealing element (13) and the closing mechanism (20).

10. The capsule (10) of claim 8 or 9, wherein the inner side wall (17) of the sealing element (13) is inclined and is arranged to be deformed in the direction of inclination.

11. The capsule (10) of claim 10, wherein the direction of inclination is away from the outer surface of the capsule body (11) and towards the rim structure edge (14).

12. The capsule according to any one of claims 1-7, wherein the capsule is provided not to deform under influence of the closing mechanism (20) of the beverage preparation apparatus.

13. The capsule (10) to any one of claims 1-12, wherein at least the inner side wall (17) of the contact element (13) is arranged at an angle with respect to an imaginary plane, which is positioned in contact with a proximal end of the inner side wall (17) that meets the upper surface (19) of the remaining portion of the rim structure (12) and perpendicular to the upper surface (19) of the rim structure (12).

14. The capsule (10) of claim 13, wherein the angle of the inner sidewall (17) of the contact element (13), measured from the imaginary plane, is preferably less than 90.0 degrees.

15. The capsule (10) of claim 14, wherein the angle of the inner sidewall (17) of the contact element (13) is preferably at least 1.0 degree, at most 90.0 degrees, preferably at most 70.0 degrees, more preferably at most 60.0 degrees, even more preferably at most 50.0 degrees.

16. The capsule (10) of claim 15, wherein the direction of inclination is away from the outer surface of the capsule body (11) and towards the rim structure edge (14).

17. The capsule (10) according to any of the preceding claims, wherein the contact element (13) is integrally formed with the rim structure (12).

18. The capsule (10) according to claim 17, wherein the contact element (13) protrusion is hollow.

19. The capsule (10) according to any of the preceding claims, wherein the rim structure (12) is integrally formed with the capsule body (11).

20. The capsule (10) of claim 19, wherein the capsule body is made at least in part from metal.

21. The capsule (10) of claim 20, wherein the capsule body (11) is made of an Aluminium-based alloy.

22. The capsule (10) according to any of the preceding claims, wherein the capsule body (11) is made at least in part from plastic.

23. The capsule (10) according to claim 22, wherein the capsule body (11) is made from a metal coated plastic based material.

24. The capsule (10) according to any of the preceding claims, wherein the height of the contact element (13), measured from the upper surface (19) of the rim structure (12) to the highest point of the contact element (13), is at least 0.2 mm, at most 3.5 mm, preferably at most 3.0 mm, more preferably at most 2.0 mm, even more preferably at most 1.5 mm.

25. The capsule according to any of the preceding claims, wherein the distance of the contact element (13) from the outer surface of the capsule body (11), measured from the highest point of the contact element (13), is at least 0.1 mm, at most 2.0 mm, preferably at most 1.5 mm, and even more preferably at most 1.0 mm.

26. The capsule (10) according to any of the preceding claims, wherein the capsule body (11) comprises a plurality of geometrical facets (16) on the outer surface of the capsule body (11).

27. A beverage preparation apparatus comprising at least an inner chamber receiving the capsule (10) according to claims 1 to 26; a closing mechanism (20) for securing the capsule (10) in the inner chamber; and a mechanism for injecting fluid at predetermined pressure in the capsule for preparing the beverage, and a mechanism for extracting the beverage from the capsule.

28. A method for using the capsule (10) according to claims 1 to 26 together with the beverage preparation apparatus according to claim 27 for a beverage preparation, the method comprising the steps of:
ensuring that the closing mechanism (20) is in the open position and that the inner chamber of the beverage apparatus is empty;
positioning the capsule (10) in the inner chamber of the beverage preparation device;
preferably securing the capsule in the inner chamber by means of a closing mechanism of the beverage preparation apparatus;
activating the mechanism for injecting fluid under pressure; and
collecting the beverage extracted from the capsule.

29. A method for producing a capsule body (11) according to claims 1 to 26 for use in the beverage preparation apparatus according to claim 27, the method comprises the steps of:
preforming the capsule body (11) and at least a portion of the rim structure (12); and
providing a contact element (13) on the rim structure (12);
characterised in that the contact element (13) is provided at predetermined distance away from the rim structure edge (14)

30. The method of claim 29, wherein the sealing element (13) is formed by applying a predetermined pressure on the rim structure (12) using an imprinter device (21, 22) having a predetermined shape.
